(19) United States
(12) Patent Application Publication
(10) Pub. No.: US 2023/0327166 A1
(43) Pub. Date: Oct. 12, 2023

(54) Protonic ceramic fuel cell system

(71) Applicant: Colorado School of Mines, Golden, CO (US)

(72) Inventors: Robert J. Braun, Lakewood, CO (US); Alexis Dubois, Golden, CO (US); Kyle J. Ferguson, Golden, CO (US)

(21) Appl. No.: 18/329,930

(22) Filed: Jun. 6, 2023

Related U.S. Application Data
(63) Continuation of application No. 17/350,734, filed on Jun. 17, 2021, now abandoned.
(60) Provisional application No. 63/040,500, filed on Jun. 17, 2020.

(51) Int. Cl. H01M 8/2425; H01M 8/0662; H01M 8/04014; H01M 8/0612; H01M 8/04007; H01M 8/04119

(52) U.S. Cl. CPC H01M 8/2425; H01M 8/0662; H01M 8/04022; H01M 8/0618; H01M 8/04074; H01M 8/04141; H01M 8/04164; H01M 2008/1293

(57) ABSTRACT

Electrochemical systems for distributed energy generation, comprising protonic ceramic fuel cells (PCFCs), are provided. The systems of the present invention allow for operation at lower stack temperatures than current solid oxide fuel cell (SOFC) systems. These systems can achieve various advantages and benefits over SOFC systems, such as higher fuel utilization, improved cell voltage, and air ratio optimization.

### CROSS-REFERENCE TO RELATED APPLICATIONS

This application is a continuation of U.S. patent application Ser. No. 17/350,734, filed Jun. 17, 2021, which claims the benefit of priority under 35 U.S.C. § 119(e) to U.S. Provisional Patent Application 63/040,500, filed 17 Jun. 2020, the entireties of both of which are incorporated herein by reference.

### STATEMENT REGARDING FEDERALLY SPONSORED RESEARCH

This invention was made with government support under grant number DE-AR0000493 awarded by the Advanced Research Projects Agency-Energy. The government has certain rights in the invention.

### FIELD OF THE INVENTION

The present invention relates generally to power generation systems, and specifically to protonic ceramic fuel cell systems and methods of using such systems.

### BACKGROUND OF THE INVENTION

Solid oxide fuel cells (SOFCs) are a scalable and efficient form of energy production, which minimize greenhouse gas emissions. SOFCs use a solid oxide electrolyte to oxidize gases by electrochemically conducting oxygen ions from a cathode to an anode. Generally, hydrogen, carbon monoxide, or a hydrocarbon molecule are oxidized on the anode side.

SOFCs do not require expensive catalyst materials. However, one drawback of SOFCs is that they require high temperatures to operate efficiently, sometimes at temperatures of 750° C. to 1000° C. High capital cost and poor durability have been significant barriers for solid oxide fuel cell technology to achieve widespread adoption in commercial distributed power generation applications. In part, these challenges have historically been associated with their high operating temperatures (750-1000° C.). While progress in cost reduction and durability has been made, even at high production volumes, relatively high balance-of-plant costs (˜760 $/kW), and low lifetime average system efficiency (45-55%) still limit their value proposition and market potential. Additionally, high temperature SOFC technology has long suffered from low robustness/durability, poor dynamic response, and high stack and balance-of-plant (BOP) costs.

There is thus a need in the art for fuel cell systems that provide some combination of lower operating temperatures, lower capital and balance-of-plant costs, higher average system efficiency, improved robustness/durability, and improved dynamic response.

### SUMMARY OF THE INVENTION

The present invention provides protonic ceramic fuel cell (PCFC) power generation systems that address the drawbacks of existing SOFC systems in several ways. First, the PCFC systems of the invention are operable at lower operating temperatures (e.g. between about 500° C. and about 700° C.), which reduces requirements for costly high-temperature-tolerant materials throughout the system, reduces heat exchanger duties, and improves the dynamic response of the system. Second, PCFC stacks according to the present invention may be manufactured by simple and inexpensive methods (e.g. single-step reaction sintering), which can result in capital cost reductions of up to 40% even when accounting for lower power cell density. Third, PCFC systems of the present invention are characterized by high internal, per-pass fuel utilization as a result of the incorporation of protonic ceramic materials, which can enable higher electric efficiency and reduced system complexity and capital cost by reducing the quantity of fresh fuel inputs needed and eliminating the need for anode gas recycling (AGR) (although AGR may still be provided for and included in some embodiments). Fourth, PCFCs are highly fuel-flexible and are generally resistant to sulfur poisoning and carbon deposition/coking within the anode fuel gas compartment, allowing for the economical and low-maintenance use of a wider variety of fuels than can be accommodated by conventional SOFC systems.

PCFC systems as described herein may be suitable for a wide range of applications, particularly small-scale distributed electricity generation applications (where efficient use of natural gas or low-carbon or renewable fuels provides greater economic and environmental benefits than utility-supplied electricity and heat) and other commercial distributed power generation applications. The systems of the present invention can quietly provide consistent, reliable electrical power at a residential or light-commercial scale using a standard natural gas connection, although it is to be expressly understood that many other fuels can be used instead of or in addition to natural gas. The system can, in embodiments, also provide hot water as a byproduct and may thus advantageously interface with existing hot water systems.

The ability to provide electricity on the scale of 1 to 10 kilowatts quietly and with minimal cost, environmental impact, and spatial footprint makes the present invention particularly valuable for remote or “off-grid” applications, including but not limited to telecommunications, recreational vehicles, cabins and other off-grid building structures, emergency and military uses (e.g. for forward operating bases, search and rescue, disaster response, etc.), mobile platforms (e.g. ships, forklifts, trucks, etc.), and oil drilling and pipeline operations. At present, power generation systems for these and other applications generally rely on either renewable (wind or solar) power generation or a reciprocal engine generator, both of which suffer from significant drawbacks—the fluctuating generation capacity of renewable systems requires the use of large battery packs or a backup system to reliably provide power, and reciprocating engine generators (e.g. diesel generators) are noisy and fuel-inefficient. The PCFC power generation systems of the present invention address these flaws by allowing for consistent, nearly silent, and highly efficient power generation, and in many cases can use fuels (e.g. oil or natural gas) that are already present onsite.

In one aspect of the present invention, a protonic ceramic fuel cell (PCFC) power generation system comprises a packed bed desulfurizer, comprising an adsorbent and configured to desulfurize a fresh fuel stream comprising at least one of hydrogen gas and a hydrocarbon; a mixing device, configured to mix the fresh fuel stream with a mixing gas to form a fuel mixture; a PCFC stack, configured to receive the fuel mixture and operate at a nominal cell temperature of between about 500° C. and about 700° C., containing repeat elements comprising a doped perovskite-based electrolyte, having an ABO_{3-δ} structure and configured to act as a proton conductor; a cathode; and an anode, comprising an impregnated catalyst configured to catalyze in situ reforming of at least one hydrocarbon to hydrogen gas; a catalytic combustor, configured to receive an anode exhaust gas and a cathode exhaust gas from the PCFC stack and combine the anode exhaust gas and the cathode exhaust gas to oxidize residual fuel constituents in the anode exhaust gas; a heat recuperation train, comprising a fuel preheater, an air preheater, and a steam evaporator, configured to recover thermal energy from at least one of the anode exhaust gas and the cathode exhaust gas and use the recovered thermal energy to preheat the fuel mixture in the mixing device; and a water recovery subsystem, configured to recover water from at least one of the anode exhaust gas and the cathode exhaust gas and recycle the recovered water for fuel reforming, wherein the mixing gas comprises at least one of steam and a recycled portion of the anode exhaust gas.

In certain embodiments, the heat recuperation train may be configured to preheat the fuel mixture to at least about 430° C.

In certain embodiments, a steam-to-carbon (S/C) molar ratio in the fuel mixture may be between about 2.0 and about 3.0.

In certain embodiments, the water recovery subsystem may comprise a water-cooled condenser, a steam re-evaporator, and a pump and may be configured to allow the system to operate in a water-neutral state.

In certain embodiments, the system may further comprise a process heat recovery sub system, configured to receive rejected heat from at least one of the packed bed desulfurizer, the mixing device, the PCFC stack, the catalytic combustor, the heat recuperation train, and the water recovery subsystem and use the rejected heat to heat a water stream and thereby form a process heat stream, and further configured to exchange heat from the process heat stream to at least one of the packed bed desulfurizer, the mixing device, the PCFC stack, the catalytic combustor, the heat recuperation train, and the water recovery subsystem.

In certain embodiments, the anode and the cathode may be part of a membrane electrode assembly, and the membrane electrode assembly may further comprise at least one electrode functional layer.

In certain embodiments, the system may further comprise an anode gas recycling (AGR) subsystem, and the AGR subsystem may comprise at least one of a recycle blower and a gas ejector. A proportion of the anode exhaust gas that is recycled by the AGR subsystem may, but need not, be between about 50% and about 90%.

In certain embodiments, the system may further comprise a catalytic hydrocarbon steam pre-reformer, and the catalytic hydrocarbon steam pre-reformer may be upstream of the PCFC stack and configured to do at least one of the following: (i) reduce at least a portion of C₂+ hydrocarbons in the fuel mixture to methane before the fuel mixture enters the PCFC stack; and (ii) reform at least a portion of hydrocarbons in the fuel mixture to hydrogen gas before the fuel mixture enters the PCFC stack.

In certain embodiments, the fresh fuel stream may comprise natural gas.

In certain embodiments, the fresh fuel stream may comprise at least one of a liquid hydrocarbon fuel, biogas, hydrogen gas, and an alcohol.

In certain embodiments, the system may have an electrical efficiency of at least about 55% LHV.

In certain embodiments, at least one of the following may be true: (i) a nominal single-cell voltage in the PCFC stack is between about 0.70 volts and about 0.90 volts; (ii) a single-pass fuel utilization of the PCFC system is between about 50% and about 75%; (iii) an overall fuel utilization of the PCFC system is between about 75% and about 95%; (iv) a temperature rise of the cathode gas within the fuel cell stack is between about 50° C. and about 150° C.; and (v) the nominal cell temperature is between about 500° C. and about 700° C.

In certain embodiments, the cathode may be a triple-conducting cathode.

In certain embodiments, the system may further comprise a cathode gas recycling (CGR) subsystem, and the CGR subsystem may comprise at least one of a recycle blower and a cathode gas ejector. A proportion of the cathode exhaust gas that is recycled by the CGR subsystem may, but need not, be between about 25% and about 75%.

In another aspect of the present invention, a method for producing electrical power comprises desulfurizing a fresh fuel stream comprising at least one of a hydrocarbon and hydrogen gas; mixing the fresh fuel stream with a mixing gas to form a fuel mixture; providing the fuel mixture to a protonic ceramic fuel cell stack to produce electrical power, an anode exhaust gas, and a cathode exhaust gas; combining the anode exhaust gas and the cathode exhaust gas in a catalytic combustor to oxidize residual fuel components in the anode exhaust gas; and recovering thermal energy from at least one of the anode exhaust gas and the cathode exhaust gas and using the recovered thermal energy to preheat the fuel mixture, wherein the mixing gas comprises at least one of steam and a recycled portion of the anode exhaust gas.

In certain embodiments, the anode exhaust gas may comprise water, and the method may further comprise recovering at least a portion of the water from the anode exhaust gas and recycling the recovered water for fuel reforming.

In certain embodiments, the cathode exhaust gas may comprise water, and the method may further comprise recovering at least a portion of the water from the cathode exhaust gas and recycling the recovered water for fuel reforming.

In certain embodiments, the method may be water-neutral.

The advantages of the present invention will be apparent from the disclosure contained herein.

As used herein, “at least one,” “one or more,” and “and/or” are open-ended expressions that are both conjunctive and disjunctive in operation. For example, each of the expressions “at least one of A, B, and C,” “at least one of A, B, or C,” one or more of A, B, and C,” “one or more of A, B, or C,” and “A, B, and/or C” means A alone, B alone, C alone, A and B together, A and C together, B and C together, or A, B, and C together.

It is to be noted that the term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The embodiments and configurations described herein are neither complete nor exhaustive. As will be appreciated, other embodiments of the invention are possible utilizing, alone or in combination, one or more of the features set forth above or described in detail below.

### BRIEF DESCRIPTION OF THE DRAWINGS

FIG. 1 is a process flowsheet for a water-neutral, 25-kilowatt protonic ceramic fuel cell (PCFC) system having an average stack temperature of 550° C., according to embodiments of the present invention.

FIG. 2A is an illustration of a membrane electrode assembly (MEA) showing electrochemical ionic transfers of protons and oxide ions in a PCFC, according to embodiments of the present invention.

FIG. 2B is a scanning electron microscope (SEM) image of a cross-section of a PCFC, according to embodiments of the present invention.

FIG. 3 is a voltage-current density (V-J) curve, according to both experimental and calibrated model data, of a button cell, according to embodiments of the present invention.

FIG. 4 is a process flow diagram for a baseline anode gas recycle (AGR) PCFC system producing 25 kilowatts net alternating current (AC) power, according to embodiments of the present invention.

FIGS. 5A and 5B are graphs showing the influence of the design cell voltage on the system net AC power, gross direct current (DC) power, and blower DC power, and on the system electrical and thermal efficiency and the thermal-to-electrical ratio, respectively, according to embodiments of the present invention.

FIG. 6 is an illustration of electrical efficiency sensitivity of the PCFC baseline design with variable conditions, according to embodiments of the present invention.

FIG. 7 is a graph of power density against cell voltage and temperature, according to embodiments of the present invention.

FIG. 8 is a system diagram and flowsheet for a PCFC system optimized for electrical efficiency without AGR, according to embodiments of the present invention.

### DETAILED DESCRIPTION OF THE INVENTION

Unless defined otherwise, all technical and scientific terms used herein have the same meaning as is commonly understood by one of ordinary skill in the art. All patents, applications, published applications, and other publications to which reference is made herein are incorporated by reference in their entirety. In the event that there is a plurality of definitions for a term herein, the definition provided in the Summary of the Invention prevails unless otherwise stated.

As used herein, unless otherwise specified, the term “Cₙ+ hydrocarbons” refers to hydrocarbons having at least n carbon atoms. By way of non-limiting example, “C₂+ hydrocarbons,” as that term is used herein, means hydrocarbons having at least two carbon atoms, e.g. ethane, propane, butane, etc.

As used herein, unless otherwise specified, the term “water-neutral” means without a need for a supplied stream of additional, or makeup, water.

For purposes of further disclosure and to comply with applicable written description and enablement requirements, the following references generally relate to solid-oxide fuel cells and/or protonic ceramic fuel cells and related compositions, devices, methods, and systems, and are hereby incorporated by reference in their entireties:
P.S.E. Ltd., gPROMS Introductory User Guide (2004).
P. J. de Wild et al., “Removal of sulphur-containing odorants from fuel gases for fuel cell-based combined heat and power applications,” 159(2) Journal of Power Sources 995 (September 2006).
Z. Y. Guo et al., “Effectiveness—thermal resistance method for heat exchanger design and analysis,” 53(13-14) International Journal of Heat and Mass Transfer 2877 (June 2010).
Kevin J. Albrecht, Physically Based Dynamic Modeling of Planar Anode-Supported SOFC Cogeneration Systems (M.S. thesis, Colorado School of Mines), 2013.
Masataka Miyamasu and Kan Akatsu, “Efficiency comparison between brushless DC motor and brushless AC motor considering driving method and machine design,” 2(1) IEEJ Journal of Industry Applications 79 (February 2013).
A. A. Trendewicz and R. J. Braun, “Techno-economic analysis of solid oxide fuel cell-based combined heat and power systems for biogas utilization at wastewater treatment facilities,” 233 Journal of Power Sources 380 (July 2013).
Christopher H. Wendel, Design and Analysis of Reversible Solid Oxide Cell Systems for Electrical Energy Storage (Ph.D. thesis, Colorado School of Mines), 2015.
Chuancheng Duan et al., “Readily processed protonic ceramic fuel cells with high performance at low temperatures,” 349 Science 1321 (September 2015) (hereinafter “Duan et al.”).
Donglin Han et al., “Transport properties of acceptor-doped barium zirconate by electromotive force measurements,” 41(33) International Journal of Hydrogen Energy 14897 (September 2016).
Alexis Dubois et al., “Benchmarking the expected stack manufacturing cost of next generation, intermediate-temperature protonic ceramic fuel cells with solid oxide fuel cell technology,” 369 Journal of Power Sources 65 (November 2017).
Huayang Zhu et al., “Thermodynamic analysis of energy efficiency and fuel utilization in protonic-ceramic fuel cells with planar co-flow configurations,” 165(11) Journal of the Electrochemical Society F942 (January 2018).
Chuancheng Duan et al., “Highly durable, coking and sulfur tolerant, fuel-flexible protonic ceramic fuel cells,” 557 Nature 217 (May 2018).
K. J. Albrecht et al., “Steady-state and dynamic modeling of intermediate-temperature protonic ceramic fuel cells,” 166(10) Journal of the Electrochemical Society F687 (January 2019) (hereinafter “Albrecht 2019”).
Robert J. Braun et al., “Development of kW-scale protonic ceramic fuel cells and systems,” 91(1) ECS Transactions 997 (July 2019).

The present invention provides power generation systems that include proton ceramic fuel cells (PCFC), and methods of using such systems, that employ balance-of-plant (BOP) fuel processing and heat recovery equipment to improve the efficiency of electric power generation. Although the embodiments of the invention are generally described herein as using a natural gas fuel, it is to be expressly understood that a wide variety of fuels may be used, including but not necessarily limited to liquid hydrocarbon fuels, biogas, syngas, and hydrogen gas. While current solid oxide fuel cell (SOFC) systems generally require operating temperatures of between about 800° C. and about 1,000° C. and must therefore employ more durable and heat-resistant (and thus more costly) materials in their construction and manufacture, the PCFC stack in systems of the present invention can operate at significantly lower temperatures (most typically between about 500° C. and about 700° C.) because power density is sufficient at these temperatures. The advantageously lower operating temperatures of the systems and methods of the present invention thus enable the systems to be constructed less expensively than current systems.

The systems and methods of the present invention can employ a liquid-cooled condenser and an exhaust-heated re-evaporator to produce steam, which can in turn be used to humidify the incoming fuel and facilitate in situ reforming of hydrocarbons in the fuel to hydrogen gas; in this way, water-neutral operation of the system can be achieved, and in some embodiments no external water source is provided. Additionally or alternatively, systems and methods of the present invention can be used to produce, in addition to electrical power, usable heat in the form of domestic hot water by heating an incoming water stream using waste heat rejected from other process units.

Further advantages of the systems and methods of the present invention are described in further detail herein. By way of first non-limiting example, systems and methods of the present invention allow for selection of system operating conditions that enable fuel-to-electricity conversion efficiencies exceeding 70% (lower heating value, LHV) without hybridization with other prime movers. By way of second non-limiting example, systems of the present invention, while generally described herein as producing power outputs on the order of about 25 kW alternating current (AC), can be designed to have any of a wide range of power outputs, generally between about 1 kW and about 10 MW.

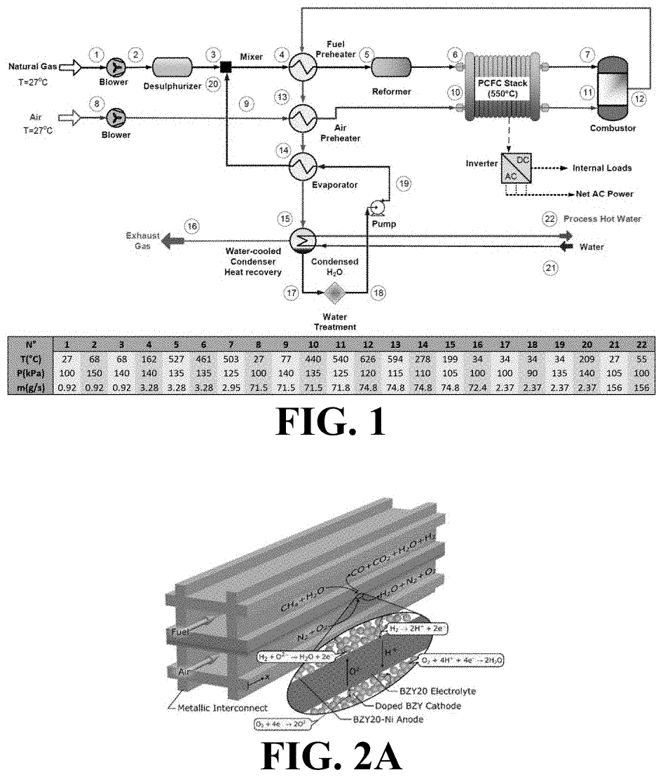

Referring now to FIG. 1, a water-neutral PCFC system comprises a blower, a water pump, a fuel compressor, a plurality of reactant gas heat exchangers, a PCFC stack, an inverter, a waste heat boiler, a burner, and a water-cooled condenser configured to recover water from stack exhaust gases. In the embodiment illustrated in FIG. 1, a fuel gas, in this case natural gas (i.e. a fluid comprising methane) enters the system and is fed to a fuel blower 1 to mitigate any pressure drop within the system. After passing through a desulfurizer 2, the fuel is mixed in a mixing device 3 with steam produced by a waste heat evaporator 14, thereby forming a methane-steam mixture; the quantity of steam is selected to provide a desired steam-to-carbon (S/C) molar ratio in the methane-steam mixture that prevents coking at the cell operating temperature (in this case 550° C.), and those skilled in the art will understand how to select such a ratio. The fuel gas mixture then enters a fuel preheater 4, which preheats the fuel gas mixture using heat derived from a PCFC stack exhaust gas, and subsequently passes through a small pre-reformer 5 before entering an anode side 6 of a PCFC stack 6. In the PCFC stack, the fuel gas mixture undergoes further internal reforming and electrochemical oxidation, producing direct current (DC) power; some of this DC power may be fed directly to operating equipment of the PCFC system, while the remainder is converted to alternating current (AC) power and delivered to an electric grid. In the embodiment illustrated in FIG. 1, the PCFC stack operates at an average nominal temperature of about 550° C., and each cell has an electrochemically active area of about 100 cm² and an average power density of about 0.150 W/m².

An air blower 8 provides an ambient air stream 9 to an air preheater 13 to heat the air to a suitable temperature (which, for an operating temperature of the PCFC stack of 550° C., is generally at least about 430° C.), whereupon the air enters a cathode side 10 of the PCFC stack. The ambient air is provided in excess of stoichiometric requirements, which maintains the cell operating temperature and prevents excessive thermal stress inside the PCFC stack.

The PCFC stack produces both a fuel exhaust gas 7 and an air exhaust gas 11, which are combined in a catalytic combustor 12 to convert any remaining combustible species into thermal energy. Hot exhaust gases from the combustor 12 are then recirculated to the fuel preheater 4 and/or the air preheater 13 to pre-heat the inlet gases, and may further provide heat for the waste heat evaporator 14. The waste heat evaporator 14 produces a low-pressure superheated steam, generally at a temperature that is about 100° C. higher than the boiling point at that pressure. To achieve water balance (i.e. ensure that the system is water-neutral), the exhaust gases are cooled to their dewpoint in a water-cooled condenser 15 such that enough condensate 17 is recovered to achieve the selected S/C ratio in the mixing device 3; the condensate is generally subjected to water treatment 18 (e.g. filtering, de-ionization, reverse osmosis, etc.) and recirculated to a recirculation inlet 20 of the mixing device 3 via a pump 19. In addition to water knockout, the condenser 17 may provide some recovered heat to the system, and may in embodiments heat an incoming water stream 21 to provide a source of domestic hot water 22 having a temperature of, e.g., about 55° C. An exhaust gas 16 of the condenser 15 is vented to the atmosphere, either with or without downstream treatment or remediation.

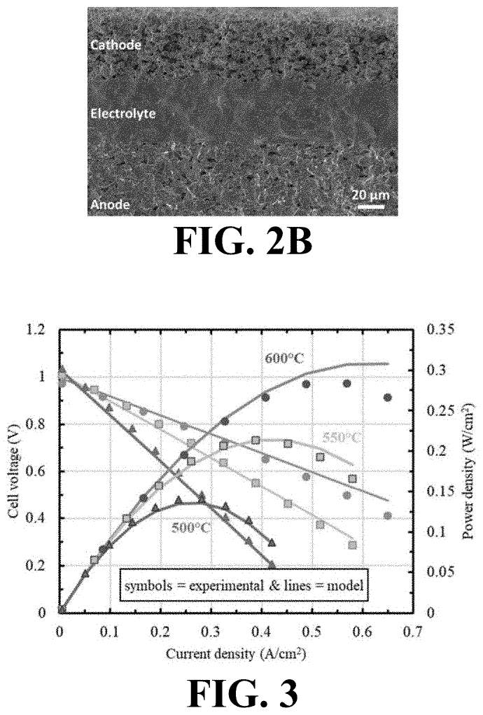

While the material sets that comprise the PCFCs described herein are generally based on the button cells designed, tested, and reported by Duan et al., numerous different types of materials that enable proton conduction, using so-called protonic ceramics, can be incorporated into system embodiments as described herein. By way of non-limiting example, the PCFCs of the present invention can incorporate a BaZr_{0.8}Y_{0.2}O_{3-δ} (BZY20) thin electrode supported by a BZY20(40%)/Ni(60%) porous anode, as illustrated in FIG. 2B. The 500 mm porous anode illustrated in FIG. 2B is impregnated with a nickel catalyst to facilitate reforming of the hydrocarbon fuel to hydrogen gas. The cathode comprises a BaCe_{0.6}Zr_{0.3}Y_{0.1}O_{3-δ} (BCZY63) backbone and a nano-infiltrated triple-conducting BaCo_{0.4}Fe_{0.4}Zr_{0.1}Y_{0.1}O_{3-δ} (BCFZY0.1) catalyst. Many other materials including protonic ceramic derived from doped perovskites with ABO_{3-δ}, such as electrolyte formulations made from BaCe_{0.7}Zr_{0.1}Y_{0.1}Yb_{0.1}O_{3-δ} (BCZYYb7111), BaCe_{0.4}Zr_{0.4}Y_{0.1}Yb_{0.1}O_{3-δ} (BCZYYb4411), and/or BaCe_{0.7}Zr_{0.1}Y_{0.2}O_{3-δ} (BCZY71) and cathode formulations typically found in state-of-the-art SOFC material systems (such as, but not limited to, lanthanum strontium-doped iron cobalt oxide, LSCF (La_{0.6}Sr_{0.4}Fe_{0.8}Co_{0.2}O_{3-δ}), or lanthanum strontium-doped manganite, LSM), may suitably be used in the practice of the invention. It is to be expressly understood that the PCFC systems disclosed herein are not limited to any specific material set or sets stated herein, but can encompass the use of any protonic ceramic electrochemical cell whose ionic conductivity enables hydrogen proton conduction through the electrolyte with or without other accompanying multiple charged defects (e.g. oxygen vacancies and/or small polarons). Similarly, while the PCFCs of the system are generally described and depicted herein as anode-supported and having an electroactive cell area of about 10 cm×10 cm, it is to be expressly understood that the PCFCs may also be electrolyte-supported and/or cathode-supported, and may have any suitable area or size. The power output of the cells may be increased by stacking the cells in repeating units and wiring them in series to increase the voltage; FIG. 2A illustrates such a repeating unit and gas flow channels therefor, with key electrochemical charge transfer reactions occurring in the fuel cell depicted.

While the protonic ceramic electrolyte employed is a mixed conductor representative of the concept of the invention, it is estimated that only between about 2.4% and about 4.6% of the current is associated with oxygen conduction and electro-oxidation of hydrogen in the anode. Thus, similar to low-temperature proton-conducting fuel cell (PEMFC) systems, anode tail gas recycle for water management may not always be sufficient to meet internal reforming requirements, and a water recovery subsystem may thus be provided to reduce makeup water requirements and maintain the water neutrality of the system.

An advantage of the PCFC systems of the invention is that the fuel is not diluted by water production at the anode, enabling higher fuel utilization. While fuel utilizations greater than 75% are theoretically possible, these utilizations may not be feasible in practice due to misdistributed flow and/or cell-to-cell voltage variations. High fuel utilization requires the fuel flowrate to be significantly lower at the outlet than at the inlet, which can cause gas flow dead zones where there is insufficient fuel for the electrochemical reactions to proceed, which in turn can lead to voltage and temperature fluctuations in the cells that can result in unpredictable cell performance or even cell failure. Thus, to achieve high system efficiency, as much of the fuel as possible must be electrochemically reacted; if high per-pass fuel utilizations are not practical, fuel recycling can be used to maintain a high overall system fuel utilization. Thus, embodiments of systems of the present invention may include anode gas recycle (AGR) to increase system fuel utilization.

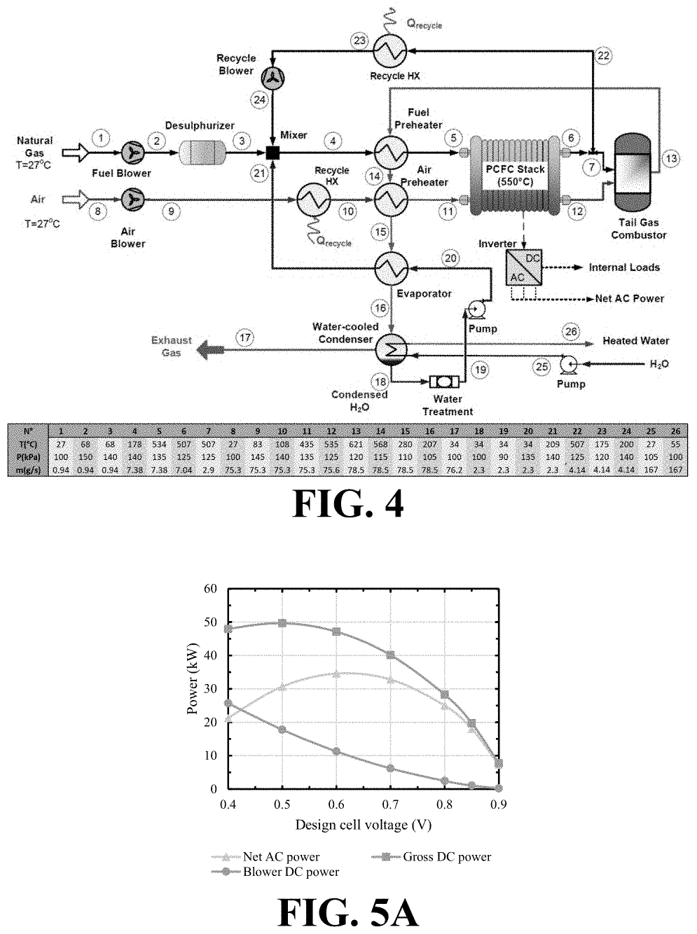

Referring now to FIG. 4, an embodiment of a PCFC system employing AGR is illustrated. The underlying principles of operation of the system illustrated in FIG. 4 are the same as those of the single-pass system illustrated in FIG. 1, except that additional heat recovery is made possible by recycling anode tail gas back to the stack inlet. Furthermore, when AGR is used, there is generally no need for a fuel pre-reformer, since the recycled tail gas will typically provide sufficient hydrogen to the fuel stream entering the fuel cell stack, and PCFCs have demonstrated significant fuel flexibility and tolerance to higher molecular weight hydrocarbons, as disclosed by Duan et al.

An additional feature of the system illustrated in FIG. 4 is the inclusion of water recirculation, which may in embodiments include filtration and purification of water before the water is supplied back to the system, to generate steam for delivery to the PCFC stack. The filtration and purification may be required or desirable to reduce fouling or poisoning of the fuel cell stack and other BOP components, as both recycled condensed water and (if required) makeup water can contain impurities that can clog, foul, or poison system components. A water purification unit may therefore be included upstream of the water intake of the evaporator; a pressure drop in this unit may generally be assumed to be about 5 kPa, and the unit can remove dissolved solids and impurities from the system. Depending upon the type of water purification (e.g., reverse osmosis), significant water rejection may be incurred, requiring a large fraction of makeup water to achieve the required water flowrate for fuel processing needs.

The evaporator component accounts for a portion of the economizing duty, evaporation, and superheat, which are modeled as three lumped counterflow heat exchangers in series. The evaporator produces the quantity of steam required to meet the S/C ratio required for internal reforming. The steam produced by the evaporator is superheated to about 100° C. above the boiling temperature of water at the steam pressure, which is generally about 1.5 bar absolute.

The following disclosed Examples illustrate and describe various embodiments and features of the present invention.

### Example 1

Cell, stack, and system performance parameters are estimated herein by the use of validated electrochemical cell models that capture the electrochemical behavior of the cell under both hydrogen gas and methane gas mixtures at scales (i.e. cell platforms) compatible with existing commercial units. Modeling of the PCFC stack to generate estimated performance characteristics is accomplished by assuming conservation of mass, energy, charge, and momentum for a steady-state, one-dimensional, channel-level cell model, with the ability to resolve distributions in temperature, gas composition, and current density in the streamwise direction. The cell model is an interface charge-transfer model that assumes isopotential electrode surfaces. The temperature-dependent charge transfer of both protons and oxide ions through the membrane is described by a semi-empirical electrochemical model based on the area-specific resistance (ASR) that accounts for polarization inside the cell, as described by Albrecht 2019.

Referring now to FIG. 3, experimental voltage-current density (V-J) data for a methane fed button cell (represented by data points) shows that the performance characteristic changes with temperature, while the voltage curve decreases nearly linearly with current density. The model-predicted performance (represented by solid lines) is then scaled to capture the performance of a complete fuel cell stack. (In FIG. 3, points represented by triangles and the corresponding curves relate to an operating temperature of 500° C.; points represented by squares and the corresponding curves relate to an operating temperature of 550° C.; and points represented by circles and the corresponding curves relate to an operating temperature of 600° C.) The results illustrated in FIG. 3 demonstrate that the up-scaled PCFC stack performance predictions described herein are representative of physical embodiments of stack platforms consistent with the cell dimensions previously described.

Generation of process statepoints within system flowsheets was accomplished by modeling balance-of-plant (BOP) components and solving for conservation of mass, chemical species, and energy with assumed performance parameters (e.g. component efficiencies). Parameters used in the thermodynamic baseline system model are summarized in Table 1 below and serve as representative examples.

TABLE 1
Input data for PCFC system performance analysis
at 25 kW_{AC} net power design target

| Parameter | Value |
|---|---|
| Cell electroactive area (cm²) | 100 |
| Cathode air temperature rise (° C.) | 100 |
| Nominal cell temperature (° C.) | 550 |
| Inverter efficiency (%) | 96 |
| Air blower efficiency (%) | 60 |
| Fuel compressor efficiency (%) | 70 |
| Pump efficiency (%) | 65 |
| Rotating equipment motor efficiency (%) | 95 |
| Per-pass fuel utilization of system (%) | 85 |
| Steam-to-carbon ratio (mol H₂O/mol CH₄) | 2.3 |
| V_{cell} (V) | 0.8 |
| j_{cell} (A/cm²) | variable |
| Boiler superheat temperature (° C.) | 100 |
| Boiler steam temperature (° C.) | 209 |

Blower, compressor, and pump efficiencies are constrained, in the models, to be comparable to those of commercial off-the-shelf units of similar capacities, and PCFC stack operating parameters are chosen so that the system operates at high efficiency while minimizing degradation of the cells.

The net electrical efficiency of the system is based upon the standard lower heating value of the fuel according to the expression

$${η}_{el , net} = \frac{{P}_{AC , net}}{{\dot{m}}_{{CH}_{4}} \cdot LHV} ,$$

where P_{AC,net} is the net power output (in kilowatts), \dot{m}_{CH}_{₄} is the mass flow of methane (in kilograms per second), and LHV is the lower heating value of natural gas (49.6 kJ/kg). The system heat loss is assumed to be 1.5% of the total LHV of the fuel entering the system localized in the fuel cell stack uniformly along the length of each cell channel.

### Example 2

Table 2 summarizes predicted system performance for the baseline design illustrated in FIG. 1, which achieves an electrical efficiency of 55.1%

TABLE 2
Output data for PCFC system performance analysis
at 25 kW_{AC} net power design target

| Parameter | Value |
|---|---|
| Excess Air Ratio (—) | 5.38 |
| Elec. Efficiency (%-LHV) | 55.1 |
| Current Density (A/cm²) | 0.191 |
| Power Density (W/cm²) | 0.153 |
| Parasitic DC power (kW) | 3.94 |
| Air HX NTU (—) | 2.13 |
| Number of Cells (—) | 1961 |

The temperature, pressure, and mass flowrates at each statepoint are provided in FIG. 1.

### Example 3

Fuel cell performance in full-scale stacks can be quite different from that produced by button-cells in the laboratory. The dimensional PCFC models built to predict stack performance account for fuel and oxidant depletion, non-isothermal cell temperatures, heat and mass transport within the cell, and internal reforming kinetics.

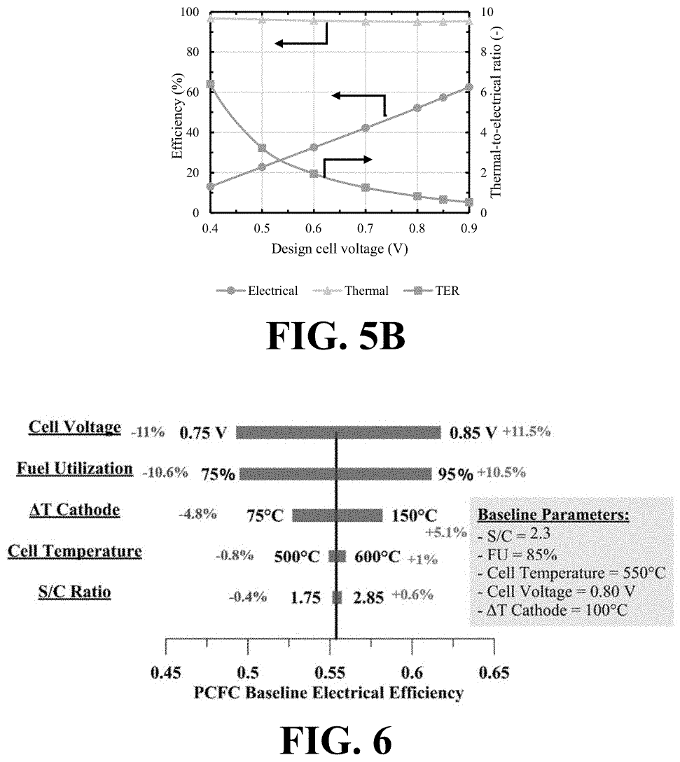

Referring now to FIGS. 5A and 5B, the influence of the design cell voltage on system and air blower power, system efficiency, and thermal-to-electrical ratio (TER) are illustrated, assuming a baseline system design with a fixed number of cells arranged in a multi-stack assembly (in this case, six stacks of 327 cells each). With increasing design cell voltage, the system electrical efficiency increases linearly. A more electrically efficient system diminishes the physical size of the BOP equipment due to higher efficiency and lower reactant flows, but the size of the fuel cell stack will increase due to lower design power density.

FIG. 5A illustrates the impact of the design cell voltage on the net AC power, the fuel cell stack gross DC power, and the air blower parasitic power. As voltage decreases, net AC power is maximized at about 35 kW at about 0.6 volts per cell, while the maximum gross DC power peaks at about 50 kW at about 0.5 volts per cell, but it should be kept in mind that operating at maximum power design points is often undesirable due to low efficiency, excessive thermal management requirements, competitive fuel/nickel oxidation, and resulting short stack lifetimes due to high current density. The power loss between gross and net power is due to inverter inefficiencies and parasitic power losses from rotary equipment; at low voltages, air blower parasitic power is about 18 kW at maximum gross DC power and about 11 kW at maximum net AC power.

FIG. 5B illustrates the influence of design cell voltage on thermal and electrical system efficiencies and the TER. While the thermal efficiency remains relatively constant at about 95%, electrical efficiency varies significantly (between about 13% and about 62.5%) over voltages between 0.4 V and 0.9 V. The tradeoffs illustrated in FIGS. 5A and 5B suggest that there may be multiple “optimal” operating conditions for PCFC systems of the present inventions; by way of non-limiting example, depending on the relative importance of thermal demand vs. electrical energy demand in a given application, the design voltage can be adapted to meet a design specification or other application-specific requirements.

### Example 4

Because operating parameters can be designed or selected for different end-use applications, the effects of five key operating parameters—fuel utilization, cell voltage, cathode air temperature rise, cell temperature, and S/C ratio—on electric efficiency were analyzed. One operating condition was varied at a time while keeping the other parameters constant. The parameter sensitivity results are provided in the form of a tornado chart in FIG. 6.

As FIG. 6 illustrates, increasing cell voltage reduces ohmic losses inside the fuel cell stack, which enables a more efficient electrochemical process and, consequently, a higher electrical efficiency (as can also be seen from FIGS. 5A and 5B). As the cell voltage increases from 0.75 V to 0.85 V, the current density decreases from about 247 mW/cm² to about 123 mW/cm², and the electrical efficiency increases by 12.5 percentage points of LHV, from 49.3% to 61.8%.

As FIG. 6 further illustrates, the change in fuel utilization affects not only electrical efficiency but also the minimum S/C ratio needed to avoid coking. As shown, the net electrical efficiency increases with increased fuel utilization due to the higher electrochemical conversion of the supplied fuel. Additionally, improvements in efficiency are realized as the parasitic power of the fuel compressor and water pump decrease due to lower reactant flows. As indicated, increasing the fuel utilization from 0.75 to 0.95 increases net electrical efficiency by 11.7 percentage points, from 49.0% to 60.7%. However, while the favorable system performance at high per-pass utilizations is attractive, uniform gas flow distribution at high utilization can be difficult to achieve in practice. System configurations that allow for high fuel utilizations are described in further detail below.

To avoid both excessively high material temperatures and thermally induced stresses (which can lead to cracks and failures inside the PCFC stack), excess air is generally provided to limit the total temperature rise of the air along the cathode side of the cell channel; in conventional SOFC systems, typical excess air ratios are between about 4 and about 6. In all high-temperature fuel cell systems, it is generally desirable to provide as low an excess air ratio as possible, as this ratio directly correlates with the size of the air pre-heater heat exchanger and air blower required; these components account for a significant proportion of the cost in the overall BOP cost of the system, and there is thus a necessary tradeoff between avoidance of thermal stresses and keeping the size of the air pre-heater manageable. As FIG. 6 illustrates, simulation results indicate that an increase in cathode air temperature rise causes an increase in the net electrical efficiency; this is because, at lower temperature rises, a higher air flow is required to maintain the cell within the desired temperature range. An increase in air temperature rise across the stack from 75° C. to 150° C. results in an increase of electrical efficiency of 5.5 percentage points, from 52.7% to 58.2%.. In addition to providing an increase in net electrical efficiency, the reduced air demand (and consequently lower air blower parasitic power) extracts less heat from the exhaust gases, which allows for a larger heat recovery at the system outlet.

As FIG. 6 further illustrates, cell temperature appears to have a significant effect only on cell power density. Electrical efficiency increases by only 1 percentage point above a baseline value after the cell operating temperature is increased from 500° C. to 600° C., which increases the cell power density from about 111 mW/cm² to about 178 mW/cm². While higher cell power densities are generally more cost-effective, the relative insensitivity of the PCFC system's electrical efficiency to temperature change is a surprising and unexpected finding.

As FIG. 6 further illustrates, variation in the design S/C ratio has relatively little effect on net electrical efficiency; while the S/C ratio is closely tied to the thermal energy required for steam production, this has no direct effect on the production of electricity in the system. As the volumetric flow of recycled steam decreases, so too do the required fuel pressure and the parasitic power (albeit, in the latter case, by a small amount). The expected increase in electrical efficiency at lower S/C ratios (due to lower parasitic power of the fuel compressor and the water pump) is effectively counter-balanced by the higher required mass flow of air in the stack, and the overall effect is that the net electrical efficiency is not sensitive to variations in the S/C ratio.

In sum, FIG. 6 illustrates that, by selecting the most optimal values for the parameters studied, electrical efficiencies approaching 70% are possible, even without recycle; this finding is described further in Example 6 below. Such high efficiencies are but one of the several advantages of the invention.

### Example 5

This Example illustrates the effect of cell voltage and cell temperature on cell power density. As is well-known in the art, power density is inversely proportional to PCFC stack cost.

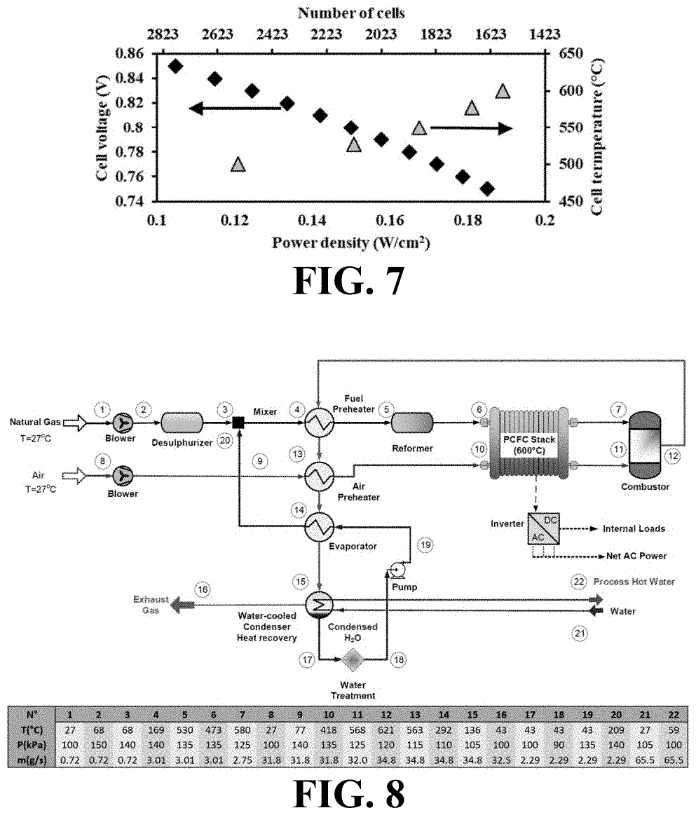

FIG. 7 illustrates that increasing cell voltage is directly beneficial for electrical efficiency, but the power density simultaneously decreases, thus increasing the required number of cells and overall stack size. Inversely, increasing cell temperature is beneficial for both electrical efficiency and power density, resulting in lower fuel consumption and a smaller, cheaper stack.

### Example 6

Based on the performance sensitivity analyses performed in Examples 4 and 5 above, an optimal set of operating parameters was determined for achieving the highest possible electrical efficiency. FIG. 8 summarizes variables and statepoints for an optimal system design, in which the stack operating temperature is 600° C., the S/C ratio is 2.85, the cathode air temperature rise is 150° C., the fuel utilization is maximized at 95%, and the cell voltage is set at 0.85 V. These parameters yield an overall LHV electrical efficiency of 69.8%.

A comparison of design and operating parameters for the baseline design illustrated in FIG. 1 and the optimized design illustrated in FIG. 8—both with and without an AGR subsystem as illustrated in FIG. 4—is given in Table 3.

TABLE 3
Energy flow between the optimized, baseline, and AGR designs

| | Baseline | Max | Baseline | Max efficiency |
|---|---|---|---|---|
| | concept | Efficiency | w/AGR | w/AGR |
| Inputs | | | | |
| Methane feed (g/s) | 0.92 | 0.72 | 0.94 | 0.71 |
| Methane LHV (MJ/kg) | 49.6 | 49.6 | 49.6 | 49.6 |
| Methane HHV (MJ/kg) | 55.5 | 55.5 | 55.5 | 55.5 |
| Fuel energy input LHV (kW) | 45.4 | 35.5 | 46.6 | 35.4 |
| Fuel energy input HHV (kW) | 50.9 | 39.7 | 52.2 | 39.6 |
| Parasitic power use (kW) | | | | |
| Methane compressor | 0.091 | 0.071 | 0.093 | 0.071 |
| Air blower | 3.84 | 1.71 | 4.49 | 1.17 |
| Water pump boiler | 1.74E−04 | 1.69E−04 | 1.68E−04 | 1.23E−04 |
| Water pump condenser | 1.27E−03 | 5.32E−04 | 1.36E−03 | 2.97E−04 |
| Losses | | | | |
| Inverter (kW) | 1.042 | 1.042 | 1.042 | 1.042 |
| Energy outputs | | | | |
| PCFC gross power kW DC | 29.98 | 27.82 | 30.77 | 27.73 |
| Net electric output kW AC | 25 | 25 | 25 | 25 |
| Efficiency | | | | |
| Electrical efficiency LHV | 55.1% | 69.8% | 53.6% | 70.6% |
| Electrical efficiency HHV | 49.2% | 62.9% | 47.9% | 63.1% |
| Performance Metrics | | | | |
| Stack Power Density (W/cm²) | 0.153 | 0.106 | 0.146 | 0.046 |
| Cell Voltage (V) | 0.8 | 0.85 | 0.8 | 0.85 |
| Recycle Ratio | [—] | [—] | 59% | 88% |
| Stack Single Pass Fuel Utilization | 85% | 95% | 70.0% | 70% |
| System Fuel Utilization | 85% | 95% | 85% | 95% |
| S/C Ratio | 2.3 | 2.85 | 2.3 | 2.31 |
| Cathode Temperature Rise (° C.) | 100 | 150 | 100 | 75 |
| Nominal Cell Temperature (° C.) | 550 | 600 | 550 | 600 |
| Stack Size (Number of Cells) | 1961 | 2632 | 2108 | 6012 |

As Table 3 shows, the optimal system requires 20% less fuel input than the baseline design for the same net output AC power of 25 kW and achieves an electrical efficiency of 69.8% LHV, compared to 55.1% for the baseline design. The fuel compressor of the optimal system consequently uses about 20% less parasitic power. About the same amount of water is recovered from the exhaust to achieve water neutrality in both systems, but the optimal design has a higher exhaust gas water content due to a smaller air ratio and a lower inlet exhaust temperature, which therefore demands less cooling from the process. The optimal design requires almost 50% less power from the condenser water pump, and more than 50% less air blower power (1.7 kW versus 3.8 kW); these results are achieved due to the higher allowable air temperature, i.e. the higher allowable increase in cathode temperature, in the optimized design.

Table 3 also shows that the baseline system performs similarly both with and without AGR (without taking cost into account). The addition of AGR reduces the single-pass fuel utilization while maintaining an identical overall fuel utilization, and the resulting electrical efficiency is nearly identical in both cases. However, AGR dilutes the incoming fuel with higher concentrations of carbon monoxide and carbon dioxide, slightly decreasing the stack power density from 0.153 W/cm² to 0.146 W/cm². This decrease in power density requires a larger (and therefore more costly) stack, and additional equipment such as a vapor heat exchanger and a recycle blower, which in turn increase system cost, complexity, and parasitic power draw.

Table 3 further shows that an optimized system including AGR, respecting the same design and operating constraints as the other systems, can achieve an electrical efficiency of 70.6%, 17 percentage points higher than the baseline (non-optimized) AGR system. The increase in system fuel utilization to the upper bound of 95% is achieved by recycling significantly more of the anode exhaust gas (88%) than in the baseline AGR system (59%). The increased recycle ratio (and thus increased dilution of the fuel with carbon monoxide and carbon dioxide), combined with a higher operating voltage, significantly reduces the stack current and power density compared to the baseline; the PCFC stack for the high-efficiency AGR system is estimated to be three times larger than in the baseline AGR case to achieve the same power output. The optimized AGR system achieves further efficiency gains by reducing the total parasitic power load by 3 kW, mostly driven the greatly (approximately 75%) reduced air flow rate and consequently lower blower power draw compared to the baseline AGR system.

Cathode gas recycle is an additional possible system configuration whose purpose is to reduce the size/duty of the air preheater and the air blower. Similar to anode gas recycle, cathode exhaust recycle can be enabled by the addition of a ‘warm’ or ‘hot’ recycle blower or the use of cathode gas ejector. In the latter case, the discharge pressure of the cathode gas blower must increase (often substantially) to provide the necessary pressure driving force to accomplish the desired amount of cathode exhaust gas recycle. In FIG. 1, a fraction of the cathode exhaust gas stream at statepoint (11) can be recirculated to mix with fresh air at either statepoint (9) or downstream of the air preheater at statepoint (10). Cathode gas recycle may also be employed in conjunction with anode gas recycle; again being implemented in a manner similar to the aforementioned scenario. Specifically, referring to FIG. 4, recirculating a fraction of the cathode exhaust (statepoint 12) to mix with fresh air at any of the statepoints 9, 10, or 11. The present invention provides PCFC power generation systems that can achieve electric efficiencies at or above 70%, even without hybridization. These systems can effectively offset lower power densities with higher fuel utilization and cell voltage and optimized air ratios, and such systems can have the further benefit of operating in a water-neutral condition. The PCFC power generation systems of the present invention thus have great promise for stationary distributed energy applications. The systems of the invention may also be combinable with internal combustion engines or other power generators (e.g. Brayton cycle- or Rankine cycle-based generators) to provide still further advantages and benefits.

The invention illustratively disclosed herein suitably may be practiced in the absence of any element which is not specifically disclosed herein. It is apparent to those skilled in the art, however, that many changes, variations, modifications, other uses, and applications of the invention are possible, and also changes, variations, modifications, other uses, and applications which do not depart from the spirit and scope of the invention are deemed to be covered by the invention, which is limited only by the claims which follow.

The foregoing discussion of the invention has been presented for purposes of illustration and description. The foregoing is not intended to limit the invention to the form or forms disclosed herein. In the foregoing Detailed Description of the Invention, for example, various features of the invention are grouped together in one or more embodiments for the purpose of streamlining the disclosure. The features of the embodiments of the invention may be combined in alternate embodiments other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description of the Invention, with each claim standing on its own as a separate preferred embodiment of the invention.

Moreover, though the description of the invention has included description of one or more embodiments and certain variations and modifications, other variations, combinations, and modifications are within the scope of the invention, e.g. as may be within the skill and knowledge of those in the art, after understanding the present disclosure. It is intended to obtain rights which include alternative embodiments to the extent permitted, including alternate, interchangeable, and/or equivalent structures, functions, ranges, or steps to those claimed, whether or not such alternate, interchangeable, and/or equivalent structures, functions, ranges, or steps are disclosed herein, and without intending to publicly dedicate any patentable subject matter.

1. A protonic ceramic fuel cell (PCFC) power generation system, comprising:
a packed bed desulfurizer, comprising an adsorbent and configured to desulfurize a fresh fuel stream comprising at least one of hydrogen gas and a hydrocarbon;
a mixing device, configured to mix the fresh fuel stream with a mixing gas to form a fuel mixture;
a PCFC stack, configured to receive the fuel mixture and operate at a nominal cell temperature of between about 500° C. and about 700° C., containing repeat elements comprising:
a doped perovskite-based electrolyte, having an ABO₃₋₆ structure and configured to act as a proton conductor;
a cathode; and
an anode, comprising an impregnated catalyst configured to catalyze in situ reforming of at least one hydrocarbon to hydrogen gas;
a catalytic combustor, configured to receive an anode exhaust gas and a cathode exhaust gas from the PCFC stack and combine the anode exhaust gas and the cathode exhaust gas to oxidize residual fuel constituents in the anode exhaust gas;
a heat recuperation train, comprising a fuel preheater, an air preheater, and a steam evaporator, configured to recover thermal energy from at least one of the anode exhaust gas and the cathode exhaust gas and use the recovered thermal energy to preheat the fuel mixture in the mixing device; and
a water recovery subsystem, configured to recover water from at least one of the anode exhaust gas and the cathode exhaust gas and recycle the recovered water for fuel reforming,
wherein the mixing gas comprises at least one of steam and a recycled portion of the anode exhaust gas.

2. The PCFC power generation system of claim 1, wherein the heat recuperation train is configured to preheat the fuel mixture to at least about 430° C.

3. The PCFC power generation system of claim 1, wherein a steam-to-carbon (S/C) molar ratio in the fuel mixture is between about 2.0 and about 3.0.

4. The PCFC power generation system of claim 1, wherein the water recovery subsystem comprises a water-cooled condenser, a steam re-evaporator, and a pump configured to allow the system to operate in a water-neutral state.

5. The PCFC power generation system of claim 1, further comprising a process heat recovery subsystem configured to receive rejected heat from at least one of the packed bed desulfurizer, the mixing device, the PCFC stack, the catalytic combustor, the heat recuperation train, and the water recovery subsystem and use the rejected heat to heat a water stream and thereby form a process heat stream, and further configured to exchange heat from the process heat stream to at least one of the packed bed desulfurizer, the mixing device, the PCFC stack, the catalytic combustor, the heat recuperation train, and the water recovery subsystem.

6. The PCFC power generation system of claim 1, wherein the anode and the cathode are part of a membrane electrode assembly which further comprises at least one electrode functional layer.

7. The PCFC power generation system of claim 1, further comprising an anode gas recycling (AGR) subsystem having at least one of a recycle blower and a gas ejector.

8. The PCFC power generation system of claim 7, wherein a proportion of the anode exhaust gas that is recycled by the AGR subsystem is between about 50% and about 90%.

9. The PCFC power generation system of claim 1, further comprising a catalytic hydrocarbon steam pre-reformer, wherein the catalytic hydrocarbon steam pre-reformer is upstream of the PCFC stack and configured to do at least one of the following:
(i) reduce at least a portion of C₂+ hydrocarbons in the fuel mixture to methane before the fuel mixture enters the PCFC stack; and
(ii) reform at least a portion of hydrocarbons in the fuel mixture to hydrogen gas before the fuel mixture enters the PCFC stack.

10. The PCFC power generation system of claim 1, wherein the fresh fuel stream comprises natural gas.

11. The PCFC power generation system of claim 1, wherein the fresh fuel stream comprises at least one of a liquid hydrocarbon fuel, a biogas, a hydrogen gas, and an alcohol.

12. The PCFC power generation system of claim 1, having an electrical efficiency of at least about 55% LHV.

13. The PCFC power generation system of claim 1, wherein at least one of the following is true:
(i) a nominal single-cell voltage in the PCFC stack is between about 0.70 volts and about 0.90 volts;
(ii) a single-pass fuel utilization of the PCFC system is between about 50% and about 75%;
(iii) an overall fuel utilization of the PCFC system is between about 75% and about 95%;
(iv) a temperature rise of the cathode gas within the fuel cell stack is between about 50° C. and about 150° C.; and
(v) the nominal cell temperature is between about 500° C. and about 700° C.

14. The PCFC power generation system of claim 1, wherein the cathode is a triple-conducting cathode.

15. The PCFC power generation system of claim 1, further comprising a cathode gas recycling (CGR) subsystem, wherein the CGR subsystem comprises at least one of a recycle blower and a cathode gas ejector.

16. The PCFC power generation system of claim 15, wherein a proportion of the cathode exhaust gas that is recycled by the CGR subsystem is between about 25% and about 75%.

17. A method for producing electrical power, comprising:
desulfurizing a fresh fuel stream comprising at least one of a hydrocarbon and hydrogen gas;
mixing the fresh fuel stream with a mixing gas to form a fuel mixture;
providing the fuel mixture to a protonic ceramic fuel cell stack to produce electrical power, an anode exhaust gas, and a cathode exhaust gas;
combining the anode exhaust gas and the cathode exhaust gas in a catalytic combustor to oxidize residual fuel components in the anode exhaust gas; and
recovering thermal energy from at least one of the anode exhaust gas and the cathode exhaust gas and using the recovered thermal energy to preheat the fuel mixture,
wherein the mixing gas comprises at least one of steam and a recycled portion of the anode exhaust gas.

18. The method of claim 17, wherein the anode exhaust gas comprises water, the method further comprising:
recovering at least a portion of the water from the anode exhaust gas and recycling the recovered water for fuel reforming.

19. The method of claim 17, wherein the cathode exhaust gas comprises water, the method further comprising:
recovering at least a portion of the water from the cathode exhaust gas and recycling the recovered water for fuel reforming.

20. The method of claim 17, wherein the method is water-neutral.
